(19) United States
(12) Patent Application Publication
(10) Pub. No.: US 2010/0212239 A1
(43) Pub. Date: Aug. 26, 2010

(54) Adjustable modular doorframe

(76) Inventor: Guo-Chi Wang, Panchiao (TW)

Correspondence Address: Guo-Chi Wang, P. O. Box 55-846, Taipei, 104, TW

(21) Appl. No.: 12/592,981

(22) Filed: Dec. 8, 2009

(30) Foreign Application Priority Data
Feb. 25, 2009 (TW) 98106018

(51) Int. Cl. E06B 1/18

(52) U.S. Cl. 52/217

(57) ABSTRACT

An adjustable modular doorframe includes a first jaw member secured on a first (or inner) side surface of a wall, and a second jaw member telescopically engageable with the first jaw member to accommodate the wall thickness and then secured to a second side (or outer) surface of the wall, thereby forming a doorframe for adjustably optionally meeting the variable thickness of the wall.

### BACKGROUND OF THE INVENTION

U.S. Pat. No. 7,533,503 disclosed a knockdown doorframe, also invented by the present inventor, includes a pair of jambs respectively secured to a right and a left vertical side wall of a doorway, each jamb having a pair of adjustable covering plates for shielding a pair of side portions of the jamb with the wall.

The adjustable cover plate includes a short engaging member (31) and a long engaging member (31a), whereby when it is provided for accommodating a wall having a narrow thickness, the short engaging member (31) is engaged with the groove of the jamb; and whereby when it is provided for accommodating another wall having wide thickness, the long engaging member (31a) is then engaged with the groove of the jamb.

However, either short engaging member (31) or long engaging member (31a) has fixed length, which is not free or optionally adjustable for variable door thickness in many construction sites.

The present inventor has found the drawbacks of the prior art and invented the present adjustable modular doorframe for free adjustment for variable door thickness.

### SUMMARY OF THE INVENTION

The object of the present invention is to provide an adjustable modular doorframe including a first jaw member secured on a first (or inner) side surface of a wall, and a second jaw member telescopically engageable with the first jaw member to accommodate the wall thickness and then secured to a second side (or outer) surface of the wall, thereby forming a doorframe for adjustably optionally meeting the variable thickness of the wall.

### BRIEF DESCRIPTION OF THE DRAWINGS

FIG. 1 is a sectional drawing of the present invention.

FIG. 2 is a modification of the present invention by inserting an extending member in between a first jaw member and a second jaw member for a wider wall.

FIG. 3 is a further modification of the present invention for a wall even thicker than that of FIG. 2.

### DETAILED DESCRIPTION

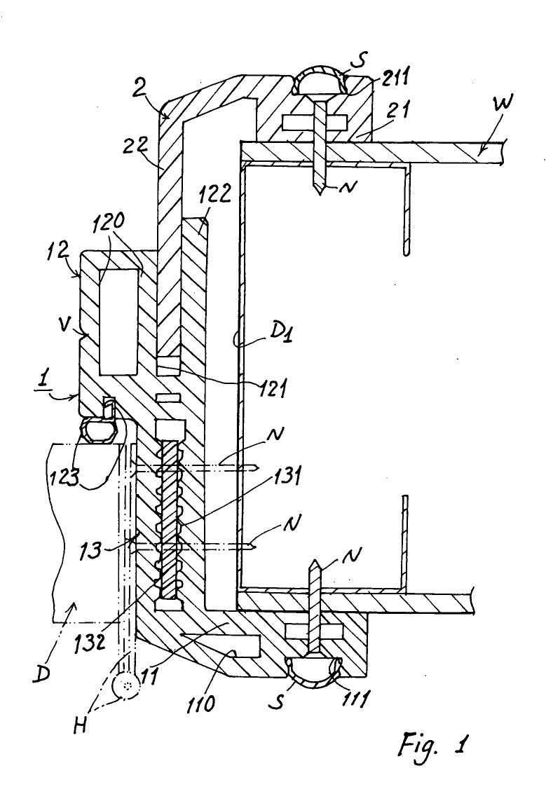

As shown in FIG. 1, the doorframe of the present invention comprise: a first jaw member 1 secured to a first side surface (or inner surface) of a wall W, and a second jaw member 2 telescopically or slidably engageable with the first jaw member 1 and secured to a second side surface (or outer surface) of the wall W.

Each jaw member 1 or 2 is made by extrusion process and may be made of plastic materials or other suitable materials. The jaw members 1, 2 may be provided for a door jamb or a lintel, not limited in the present invention. As illustrated in the accompanying drawings, the elements are observed by their cross sectional views.

The first jaw member 1 includes: a base portion 11 secured to the first side surface (or inner surface) of the wall W such as by fixing nail N into the wall W through a nail groove 111 recessed in the base portion 11 having a decorative strip S covering the nail groove 111; a holding portion 13 integrally formed with the base portion 11; and a clamping portion 12 bifurcated from the holding portion 13 for telescopically or slidably engaging the second jaw member 2.

The base portion 11, the holding portion 13 and the clamping portion 12 are integrally formed, such as by extrusion process, to form a hollow portion 110 of trapetroid shape (in a cross sectional view thereof) in the base portion 11; a cross-sectional rectangular hollow portion 131 in the holding portion 13; and a reinforcing hollow protrusion 120 of rectangular shape (cross sectional view) in the clamping portion 12.

Such a hollow portion or protrusion 110, 130, 120 is integrally formed by extrusion process to form a rigid “box” structure for reinforcing strength of each portion 11, 13, 12 of the jaw member 1.

The holding portion 13 further includes a reinforcing insert 132 co-extruded in the hollow portion 131 of the holding portion 13 when forming the first jaw member 1 by extrusion process. Such a reinforcing insert 132 may be made of plastic strip including PVC strip, whereby upon fixing of nails N through a door hinge H and the holding portion 13 on the end wall D₁ of the wall W, the reinforcing insert 132 will reinforce the holding portion 13 and help stabilize the fixation of the door hinge H, the door D and the doorframe itself on the wall W as shown in FIG. 1.

The clamping portion 12 as bifurcated from the holding portion 13 includes: a reinforcing hollow protrusion 120 for retarding the door D when closed, a backing clip 122 juxtapositioned to the reinforcing hollow protrusion 120 having a slot 121 recessed in between the reinforcing hollow protrusion 120 and the backing clip 122 for slidably engaging the second jaw member 2 in the slot 121.

The reinforcing hollow protrusion 120 is integrally formed with the first jaw member 1 by extrusion process to form a rectangular rigid “box” or “frame” on the hollow protrusion 120 to reinforce the strength of the jaw member 1 and the doorframe.

A sealing member 123 is provided on the reinforcing hollow protrusion 120 of the clamping portion 12 for sealing an aperture between the door D and the clamping portion 12 when closing the door.

So, the reinforcing hollow protrusion 120 of the clamping portion 12 will reinforce the strength of the clamping portion 12 and will also serve as a “stopper” for limiting the door D when closed.

The geometrical shapes of the hollow portions or protrusion 110, 131, 120 are not limited in the present invention.

A notch or recess V may be formed on the surface of the clamping portion 12 for decorative purpose.

The second jaw member 2 includes: a retaining portion 21 securable to a second side surface (or outer surface) of the wall W such as by fixing nail N into the wall W through a nail groove 211 recessed in the retaining portion 21 having a decorative strip S covering the groove 211; and a latch portion 22 integrally formed with the retaining portion 21 and telescopically or slidably engageable with the slot 121 recessed in the clamping portion 12 of the first jaw member 1 for accommodating a thickness of the wall W.

The second jaw member 2 may also be formed by extrusion process and made of plastic materials or other suitable materials.

When installing the doorframe of the present invention onto a doorway of a wall W, the first jaw member 1 is secured to the inner side surface of the wall, and the second jaw member 2, having its latch portion 22 slidably or telescopically engaging with the slot 121 in the first jaw member 1 until matching the thickness of the wall W, is then fixed to the outer side surface of the wall to integrate or form the doorframe. Since the latch portion 22 of the second jaw member 2 is concealed within the slot 121 of the first jaw member 1, the appearance of the doorframe will be so smooth, without revealing any track or aperture between the two jaw members 1, 2, and will not influence the interior decoration or upholstering effect.

The latch portion 22 of the second jaw member 2 is free or optionally engageable with the slot 121 in the first jaw member 1 to thereby optionally accommodate the variable thickness of the wall W for a convenient construction in a working site or place. So, the present invention may be used for a free adjustment to match any thickness of the wall, well serving as a knockdown doorframe which may be directly quickly and conveniently installed in a construction site or place.

Since the jaw members 1, 2 are pre-fabricated such as by extrusion or co-extrusion processes, the production and installation cost can be greatly reduced.

Meanwhile, the two jaw members 1, 2 may be well adjusted to be adapted for variable door thickness, door width, verticality or horizontality of jamb or lintel.

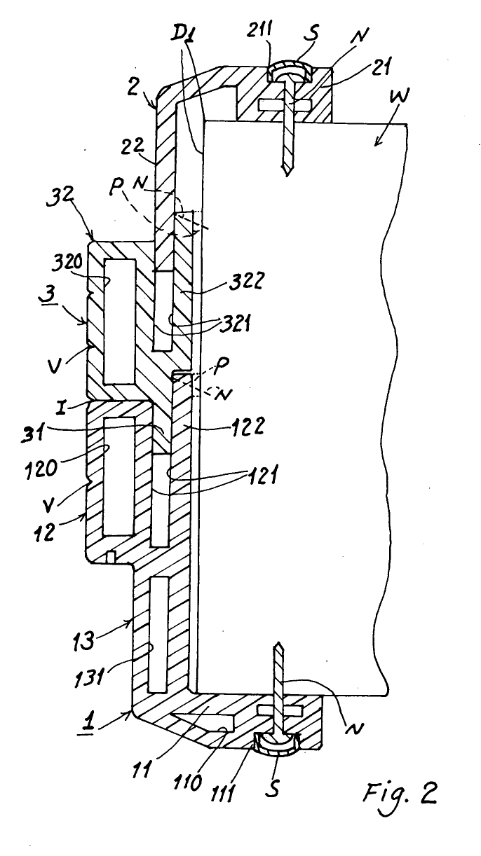

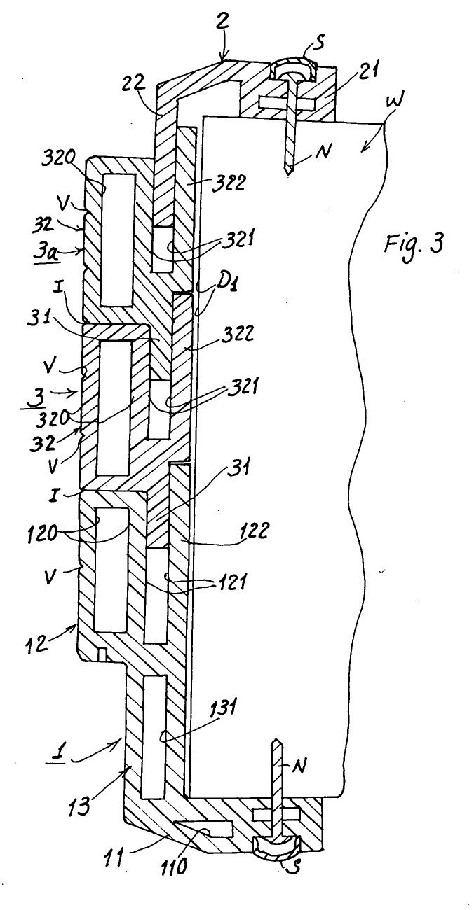

For a wider wall, at least an extending member 3 may be inserted in between the first and second jaw members 1, 2 as shown in FIGS. 2 and 3. However, the number of the extending members 3 as inserted between the jaw members 1, 2 are not limited.

The extending member 3 includes: a tongue portion 31 telescopically or slidably engageable with the slot 121 of the first jaw member 1; and a fork portion 32 bifurcated from the tongue portion 31 and including a reinforcing box portion 320 generally corresponding to the reinforcing hollow protrusion 120 of the first jaw member 1, a coupling clip 322 juxtapositioned to the reinforcing box portion 320 having a groove 321 recessed in between the reinforcing box portion 320 and the coupling clip 322 for slidably engaging the latch portion 22 of the second jaw member 2 in the groove 321.

By engaging the tongue portion 31 of the extending member 3 with the slot 121 in the first jaw member 1 and by engaging the latch portion 22 of the second jaw member 2 with the groove 321 of the extending member 3 as shown in FIG. 2, the extending member 3 is inserted in between the first jaw member 1 and the second jaw member 2 to accommodate a thicker door having a thickness larger than that of FIG. 1.

A packing or pad P may be inserted in between the end wall D₁ and the backing clip 122 or the coupling clip 322 and then a nail N is provided to fix the clip 322 or 122 on the end wall D₁ of the wall W for enhancing stability or fixing strength of the doorframe on the wall W.

At least a notch V is formed on the surface of the reinforcing box portion 320 for decorative purpose and also to “camouflage” the aperture I between the reinforcing box portion 320 and the reinforcing hollow protrusion 120 for enhancing an overall decoration. Otherwise, the aperture I, if without being camouflaged by the notch or notches V, may be misled as a breaking line or damaged slit to affect the overall decoration or appearance of the doorframe.

As shown in FIG. 3, a first extending member 3 and a second extending member 3a are consecutively inserted in between the first jaw member 1 and the second jaw member 2 to accommodate a wide door having a thickness even wider than that as shown in FIG. 2.

The extending member 3 may be prefabricated such as by extrusion process, so that a plurality of extending members 3, 3a . . . may be provided to accommodate a wide wall, thereby satisfying the requirement of a doorframe for a wall with great range of wall thickness.

Each extending member 3 or 3a has its tongue portion 31 slidably engageable with the slot 121 of the first jaw member 1, and also having the tongue portion 31 slidably engageable with the groove 321 of another neighboring extending member 3 so that plural extending members may be consecutively coupled and inserted in between the first jaw member 1 and the second jaw member 2 as shown in FIG. 3.

Simultaneously, the groove 321 of each extending member 3 is slidably engageable with either the latch portion 22 of the second jaw member 2 or engageable with the tongue portion 31 of an extending member.

By the way, the first extending member 3 as shown in FIG. 3 has its tongue portion 31 slidably engageable with the slot 121 of the first jaw member 1 and having its groove 321 slidably engageable with another tongue portion 31 of the second extending member 3a; while the second extending member 3a having its groove 321 slidably engageable with the latch portion 22 of the second jaw member 2. Then, the two extending members 3, 3a are consecutively inserted in between the two jaw members 1, 2 for forming a doorframe adapted for meeting the wide wall W as shown in FIG. 3.

The present invention may be modified without departing from the spirit and scope of the present invention.

I claim:

1. A doorframe comprising:
a first jaw member secured to a first side surface of a wall, and a second jaw member telescopically or slidably engaging with the first jaw member to accommodate a thickness of the wall and secured to a second side surface of the wall to form the doorframe; and
each said jaw member formed as extruded by an extrusion process.

2. A doorframe according to claim 1, wherein said first jaw member includes: a base portion secured to the first side surface of the wall; a holding portion integrally formed with the base portion; and a clamping portion bifurcated from the holding portion for telescopically or slidably engaging the second jaw member.

3. A doorframe according to claim 2, wherein the base portion, the holding portion and the clamping portion of said first jaw member are integrally formed by extrusion process, to respectively form a first hollow portion in the base portion; a second hollow portion in the holding portion; and a reinforcing hollow protrusion in the clamping portion.

4. A doorframe according to claim 3, wherein each said hollow portion or said hollow protrusion is integrally formed by extrusion process to form a rigid box structure for reinforcing strength of each said hollow portion or said hollow protrusion of the first jaw member.

5. A doorframe according to claim 3, wherein said holding portion further includes a reinforcing insert co-extruded in the hollow portion of the holding portion when forming the first jaw member by extrusion process.

6. A doorframe according to claim 2, wherein said clamping portion as bifurcated from the holding portion includes: a reinforcing hollow protrusion for retarding the door when closed, a backing clip juxtapositioned to the reinforcing hollow protrusion having a slot recessed in between the reinforcing hollow protrusion and the backing clip for slidably engaging the second jaw member in the slot.

7. A doorframe according to claim 6, wherein said clamping portion includes at least a notch formed on the surface of the clamping portion for decorative purpose.

8. A doorframe according to claim 2, wherein said second jaw member includes: a retaining portion secured to a second side surface of the wall; and a latch portion integrally formed with the retaining portion and telescopically or slidably engageable with a slot recessed in the clamping portion of the first jaw member for accommodating a thickness of the wall.

9. A doorframe according to claim 1, wherein said first and said second jaw members further include at least an extending member inserted therebetween; said extending member including: a tongue portion telescopically or slidably engageable with a slot of the first jaw member; and a fork portion bifurcated from the tongue portion and including a reinforcing box portion generally corresponding to a reinforcing hollow protrusion of the first jaw member, a coupling clip juxtapositioned to the reinforcing box portion having a groove recessed in between the reinforcing box portion and the coupling clip for slidably engaging a latch portion of the second jaw member in the groove.

10. A doorframe according to claim 9, wherein said first jaw member and said extending member each includes a packing inserted in between an end wall of the wall and each said jaw member or said extending member for enhancing stability strength of the doorframe on the wall.

11. A doorframe according to claim 9, wherein said extending member includes at least a notch formed on the surface of the reinforcing box portion for decorative purpose and also to camouflage an aperture between the reinforcing box portion and the reinforcing hollow protrusion for enhancing an overall decoration.

12. A doorframe according to claim 9, wherein said extending member is prefabricated by extrusion process.

13. A doorframe according to claim 9, wherein a first said extending member has its tongue portion slidably engageable with the slot of the first jaw member, and a second extending member having its tongue portion slidably engageable with a groove of said first extending member and having said groove in said second extending member engaging with said latch portion of said second jaw member, so that at least two said extending members are consecutively coupled and inserted in between the first jaw member and the second jaw member.
